(19) United States
(12) Patent Application Publication
(10) Pub. No.: US 2008/0079869 A1
(43) Pub. Date: Apr. 3, 2008

(54) DIFFUSION PLATE, BACKLIGHT UNIT, LIQUID CRYSTAL DISPLAY, METHOD FOR MANUFACTURING DIFFUSION PLATE, AND METHOD FOR ENHANCING COLOR REPRODUCIBILITY

(75) Inventors: Jung-Wook PAEK, Suwon-si (KR); Ju-Hwa HA, Seoul (KR); Jin-Soo KIM, Seoul (KR); Byung-Yun JOO, Goyang-si (KR); Jin-Sung CHOI, Cheonan-si (KR); Min-Young SONG, Daejeon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/863,742

(22) Filed: Sep. 28, 2007

(30) Foreign Application Priority Data
Sep. 28, 2006 (KR) 10-2006-0094585

(51) Int. Cl. G02F 1/13357

(52) U.S. Cl. 349/64; 349/62

(57) ABSTRACT

A light absorption material absorbing a light of a dummy wavelength range or noises is added to a diffusion plate to remove light of an unnecessary wavelength band when using a cold cathode fluorescent lamp (“CCFL”) to enhance color reproducibility. Because the light absorption material is simply included in the diffusion plate, a fabrication or development cost can be reduced, and because a production line is not necessary, costs can be saved.

This application claims priority to Korean Patent Application No. 10-2006-0094585, filed on Sep. 28, 2006 and all the benefits accruing therefrom under 35 U.S.C. §119, and the contents of which in its entirety are herein incorporated by reference.

### BACKGROUND OF THE INVENTION

(a) Field of the Invention

The present invention relates to a diffusion plate, a backlight unit, a liquid crystal display (LCD), a method for manufacturing a diffusion plate, and a method for enhancing color reproducibility. More particularly, the present invention relates to a diffusion plate enhancing color reproducibility of an LCD, a backlight unit and an LCD having the diffusion plate, a method for manufacturing the diffusion plate, and a method for enhancing color reproducibility in a display device.

(b) Description of the Related Art

The LCD is a non-emissive device that does not emit light by itself, so it includes a backlight unit for providing light to a liquid crystal panel of the LCD from a lower side of the liquid crystal panel. The backlight unit includes a lamp, a light guide plate, a diffusion plate, a reflection sheet, an optical sheet, etc.

The diffusion plate is used to make light provided from the backlight unit have a uniform luminance distribution over the liquid crystal panel, increase luminance, and evenly spread the light.

When a cold cathode fluorescent lamp (“CCFL”) is used as a light source, light, other than red, green, and blue colors, has luminance of above a certain level. Thus, when an image is displayed by using the CCFL, unnecessary color is added to degrade color reproducibility.

### BRIEF SUMMARY OF THE INVENTION

Exemplary embodiments of the present invention provide a diffusion plate including a main body, diffusers distributed in the main body, and a light absorption material. The light absorption material may be formed on one surface of the main body, on a surface of the diffusers, or distributed in the main body.

The light absorption material may absorb at least some light within a wavelength range of 480±20 nm. The light absorption material may be a photochromic dye, such as Reversacol™ Rush Yellow of James Robinson Ltd. The light absorption material may absorb at least some light within a wavelength range of 580±20 nm. The light absorption material may be a photochromic dye, such as Reversacol™ Flame of James Robinson Ltd.

In either case, the light absorption material may reduce luminance of light transmitting through the diffusion plate such that a luminance difference between light made incident on the diffusion plate and light transmitting through the diffusion plate within the wavelength range is 20% or greater.

The light absorption material may prevent at least some light having wavelengths between wavelengths of red and green light, and at least some light having wavelengths between wavelengths of green and blue light from transmitting through the diffusion plate.

Still other exemplary embodiments of the present invention provide a backlight unit including a cold cathode fluorescent lamp (“CCFL”), a light guide plate guiding light emitted from the CCFL, and a diffusion plate formed at an upper portion of the light guide plate, wherein the diffusion plate includes a main body, diffusers distributed within the main body, and a light absorption material. The light absorption material may be formed on one surface of the main body, formed on a surface of the diffusers, or distributed within the main body.

The light absorption material may absorb at least some light within a wavelength range of 480±20 nm, and/or the light absorption material may absorb at least some light within a wavelength range of 580±20 nm.

Other exemplary embodiments of the present invention provide a liquid crystal display (“LCD”) including a backlight unit including a CCFL, a light guide plate guiding light emitted from the CCFL, and a diffusion plate formed at an upper portion of the light guide plate, and a liquid crystal panel displaying an image by using light provided from the backlight unit. The diffusion plate includes a main body, diffusers distributed within the main body, and a light absorption material. The light absorption material may be formed on one surface of the main body, formed on a surface of the diffusers, or distributed within the main body.

The light absorption material may absorb at least some light within a wavelength range of 480±20 nm, and/or at least some light within a wavelength range of 580±20 nm.

Other exemplary embodiments of the present invention provide a method for manufacturing a diffusion plate, the method including adding diffusers to be distributed in a main body to a material for forming the main body and extruding or injecting the main body having the diffusers to form a plate, and coating an absorption material on one surface of the plate.

Other exemplary embodiments of the present invention provide a method for manufacturing a diffusion plate, the method including coating a light absorption material on a surface of diffusers, and including the diffusers coated with the light absorption material to a material for forming a diffusion plate main body and extruding or injecting the material forming a diffusion plate main body to form a diffusion plate.

Other exemplary embodiments of the present invention provide a method for manufacturing a diffusion plate, the method including adding diffusers, to be distributed in a main body of a diffusion plate, and a light absorption material to a material for forming the main body of the diffusion plate, and extruding or injecting the material for forming the main body to form the diffusion plate.

In the above-described methods for manufacturing a diffusion plate, the light absorption material may absorb at least some light within a wavelength range of 480±20 nm and/or at least some light having a wavelength range of 580±20 nm.

Other exemplary embodiments of the present invention include a method for enhancing color reproducibility in a display device, the display device including a display panel and a backlight unit, the backlight unit including a light source and a diffusion plate, the diffusion plate having a main body material and diffusers, the method including adding a light absorption material to the diffusion plate, the light absorption material preventing transmission of at least some light within a wavelength band through the diffusion plate. The light absorption material may prevent transmission of at least some light within at least one of two wavelength bands including a first wavelength band between 480±20 nm and a second wavelength band between 580±20 nm. Adding a light absorption material to the diffusion plate may include adding a photochromic dye to the diffusion plate.

### BRIEF DESCRIPTION OF THE DRAWINGS

The above and/or other aspects, features, and advantages of the present invention will become apparent and more readily appreciated from the following description of the embodiments, taken in conjunction with the accompany drawings of which:

FIG. 1 is an exploded perspective view of an exemplary liquid crystal display (“LCD”) according to one exemplary embodiment of the present invention;

FIG. 2 is a graph showing light intensity over wavelengths obtained after light provided from a light source is transmitted through color filters of the prior art;

FIG. 3 is a graph showing color reproducibility represented by light sources of the prior art;

FIGS. 4 to 6 show sections of exemplary diffusion plates according to exemplary embodiments of the present invention;

FIG. 7 is a graph showing transmission characteristics according to an exemplary embodiment of the present invention;

FIG. 8 is a graph showing transmission characteristics according to the exemplary embodiment of the present invention;

FIG. 9 is a graph showing characteristics of the related art diffusion plate through transmittance over wavelengths;

FIG. 10 is a graph showing characteristics of an exemplary diffusion plate according to an exemplary embodiment of the present invention through transmittance over wavelengths;

FIG. 11 is a graph showing characteristics according to wavelengths of light transmitting through an exemplary diffusion plate according to one exemplary embodiment of the present invention; and,

FIG. 12 is a graph showing characteristics according to wavelengths of light transmitting through an exemplary diffusion plate according to another exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

The present invention is directed to enhance color reproducibility of a liquid crystal display (“LCD”) that uses a cold cathode fluorescent lamp (“CCFL”). In the present invention, a light absorption material for absorbing a particular wavelength is added to a diffusion plate to enhance color reproducibility.

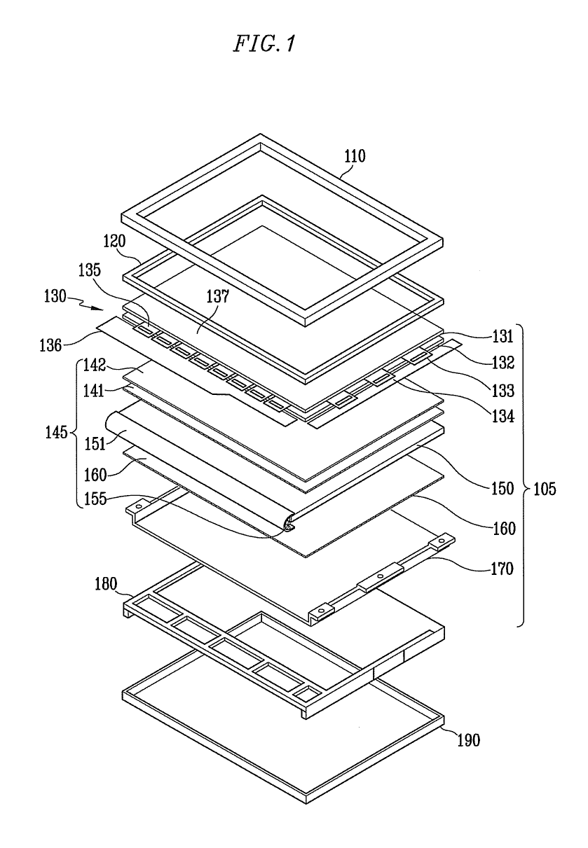

First, an exemplary LCD according to one exemplary embodiment of the present invention will be described in detail with reference to FIG. 1.

As shown in FIG. 1, an LCD according to one exemplary embodiment of the present invention includes a liquid crystal module 105, and a front case 110 and a rear case 190 for protecting the liquid crystal module 105 there between. The liquid crystal module 105 includes a liquid crystal panel assembly 130 for displaying an image and a backlight unit 145 for providing light to the liquid crystal panel assembly 130 from a lower side of the liquid crystal panel assembly 130. The liquid crystal panel assembly includes a liquid crystal panel 137, a data tape carrier package (“TCP”) 135, a data printed circuit board (“PCB”) 136, a gate TCP 133, and a gate PCB 134.

The liquid crystal panel 137 includes a TFT array panel 132, a color filter panel 131 positioned at an upper side of the TFT array panel 132, and liquid crystal (not shown) injected between the panels 131, 132. The TFT array panel 132 includes thin film transistors (“TFTs”) (not shown) serving as switching elements formed in a matrix. Although not shown, the TFT array panel 132 also includes a gate line connected with a gate electrode of each TFT, a data line connected with a source electrode of each TFT, and a pixel electrode connected with a drain electrode of each TFT.

The data lines and gate lines are electrically connected with the data PCB 136 and the gate PCB 134 through the data TCP 135 and the gate TCP 133, respectively. Accordingly, when the data PCB 136 and the gate PCB 134 receive electrical signals from outside, they transmit a drive signal and a timing signal, etc., for controlling driving and a driving time of the liquid crystal panel assembly 130 to the data lines and the gate lines through the data TCP 135 and the gate TCP 133, respectively.

The color filter panel 131 includes red, green, and blue (“RGB”) color filters for displaying an image, through which light transmitted through liquid crystal in the liquid crystal layer formed between the color filter panel 131 and the TFT array panel 132 can appear in various colors. A common electrode (not shown) is formed on a front surface of the color filter panel 131. Thus, when a voltage is applied to the liquid crystal panel 137, an electric field is formed between the common electrode and the pixel electrode of the TFTs to change an arrangement of liquid crystals positioned there between.

While a particular arrangement of the LC panel assembly 130 has been illustrated and described, alternate arrangements of the LC panel assembly 130 are also within the scope of these embodiments.

The liquid crystal is a non-emissive element, that is, it cannot emit light, so the liquid crystal module 105 includes the backlight unit 145 for providing light to the liquid crystal panel 137. The backlight unit 145 is arranged to provide light from a lower side of the liquid crystal panel assembly 130, such as through the lower surface of the TFT array panel 132. The backlight unit 145 includes a cold cathode fluorescent lamp (“CCFL”) 155 for generating light and a light guide plate 150 for guiding light generated from the CCFL 155 to the liquid crystal panel 137. The backlight unit 145 further includes a lamp cover 151 surrounding the CCFL 155 to protect the CCFL 155 and to reflect light, which may not proceed directly to the light guide plate 150 after being emanated from the CCFL 155, towards the light guide plate 150. In the exemplary embodiment of the present invention, the CCFL 155 is positioned at the side of the light guide plate 150, but it can be also formed at a lower portion of the light guide plate 150. Also, although only one CCFL 155 is illustrated, the CCFL 155 may be provided in plural.

The light guide plate 150 is positioned at a lower side of the liquid crystal panel 137, has a size corresponding to the liquid crystal panel 137, and changes a path of light emitted from the CCFL 155 to guide it to the liquid crystal panel 137. While a particular arrangement of the CCFL 155 and light guide plate 150 have been illustrated and described, other arrangements of these elements would also be within the scope of these embodiments.

At an upper side of the light guide plate 150, there are provided a diffusion plate 141 for making luminance of light proceeding to the liquid crystal panel 137 uniform, and a plurality of optical sheets, and in the exemplary embodiment of the present invention, the diffusion plate 141 and a plurality of optical films 142 having a light collecting function or diffusion function are used. In the exemplary embodiment of the present invention, the diffusion plate 141 not only evenly distributes light provided from the backlight unit 145 but also absorbs light of a dummy wavelength range or noises, as will be further described below. As the plurality of optical films 142, a prism film for strengthening luminance upon collecting light or a film having a diffusion structure for diffusing light is used.

A reflector 160 is provided at a lower side of the light guide plate 150 in order to reflect light leaked from the light guide plate 150 and send the reflected light back toward the liquid crystal panel 137 to thus improve efficiency of light.

The liquid crystal panel assembly 130 and the backlight unit 145 are received in a bottom chassis 170, which is a receiving container and is fixedly supported by a molded frame 180. A bottom surface of the molded frame 180 is opened to expose a rear surface of the bottom chassis 170. Portions of the molded frame 180, where the data PCB 136 and the gate PCB 134 are bent to be mounted, are opened to allow circuit components mounted at the data PCB 136 and the gate PCB 134 to be smoothly received.

Although not shown in FIG. 1, an inverter board and a signal conversion PCB are installed on the rear surface of the bottom chassis 170 exposed through the opened bottom surface of the molded frame 180. The inverter board transforms external power to a certain voltage level and provides power to the CCFL 155, and the signal conversion PCB is connected with the data PCB 136 and the gate PCB 134 to convert an analog data signal into a digital data signal and provide the converted digital data signal to the liquid crystal panel 137.

A top chassis 120 is provided at an upper side of the liquid crystal panel assembly 130 in order to bend the data PCB 136 and the gate PCB 134 to the outside of the molded frame 180 and prevent the liquid crystal panel assembly 130 from being released from the bottom chassis 170. As the top chassis 120 and the molded frame 180 are combined with the front case 110 and the rear case 190, respectively, the LCD is formed.

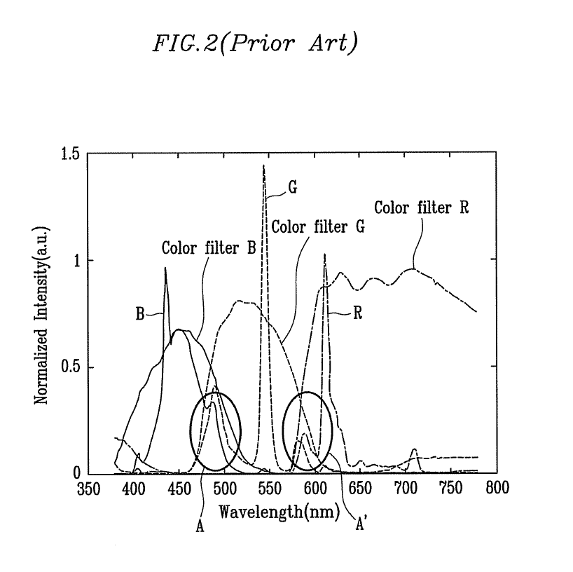

FIG. 2 is a graph showing light intensity over wavelengths obtained after light emitted from a light source is transmitted through color filters in the prior art.

In the graph shown in FIG. 2, color filter B, color filter G, and color filter R in the graph indicate transmission characteristics over wavelength bands of blue, green, and red color filters, respectively. “B”, “G”, and “R” in the graph indicate intensity of light over wavelengths after light emitted from a CCFL transmits through the blue, green, and red color filters. In FIG. 2, A and A′, indicate regions where color reproducibility is degraded due to an unnecessary component when colors are displayed by using the CCFL.

The region A has a wavelength of 480±20 nm and the region A′ has a wavelength of 580±20 nm.

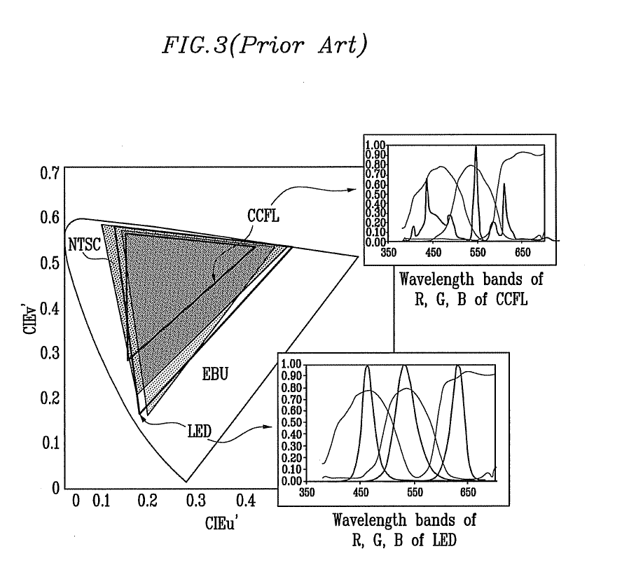

Namely, an LCD generally expresses color by combining the three colors of blue, green, and red, and in this case, when the CCFL is used as the light source, color reproducibility is degraded because of existence of a color besides the three colors blue, green, and red as shown in FIG. 3.

FIG. 3 is a graph showing color reproducibility represented by light sources of the prior art.

FIG. 3 shows three types of graphs, of which the left one shows color coordinates according to comparison of color reproducibility by types and light sources. The right upper graph shows intensity of light over wavelengths when the CCFL is used such as in FIG. 2, and the right lower graph shows intensity of light over wavelengths when an LED is used as a light source.

In comparison, when the CCFL is used as the light source as shown in the right upper graph, light of unnecessary wavelengths such as at the regions A and A′ in FIG. 2 are included, while in the case of the LED according to the right lower graph, it is noted that there is almost no color other than the three colors red, green, and blue.

Based on the comparison, it can be observed that the CCFL has a smaller color region that can be expressed compared with the LED. In the left graph, National Television System Committee (“NTSC”) and European Broadcasting Union (“EBU”) indicate a color region expressed by a display device of each corresponding method. For example, Korea employs the NTSC method, so color reproducibility is commonly evaluated in Korea based on the color range expressed by the NTSC method.

It can be noted that, compared with the NTSC method, the LCD using the CCFL cannot cover many colors to represent them.

In order to solve the problem of the CCFL, in the present invention, a light absorption material 20 is included in the diffusion plate 141 of the LCD to absorb light of the regions A and A′ in FIG. 2. The regions “A” and “A” represent dummy wavelength ranges, in other words, noises.

FIGS. 4 to 6 show sections of the exemplary diffusion plate according to exemplary embodiments of the present invention.

First, FIG. 4 shows an example in which the light absorption material 20 is coated on a lower surface of the main body 10 of the diffusion plate 141, where the lower surface faces the light guide plate 150. The diffusion plate 141 has a structure such that a plurality of diffusers 15 for diffusing light are distributed in the main body 10. In the illustrated embodiment, the light absorption material 20 is coated on the entire lower surface of the main body 10. As the light absorption material 20, a material for removing light corresponding to the region A (having the wavelength of 480±20 nm) or the region A′ (having the wavelength of 580±20 nm) is used. Two types of materials for removing light corresponding to both regions A and A′ can also be used.

In the present exemplary embodiment of the present invention, the light absorption material 20 is coated on the lower surface of the main body 10, but it can also be coated on an upper surface of the main body 10 that faces the optical film 142. Practically, however, it is more effective to coat the light absorption material 20 on the lower surface of the main body 10 than on the upper surface of the main body 10.

In the present exemplary embodiment of the present invention, for the light absorption material 20 for absorbing light of the region A having the wavelength 480±20 nm, a photochromic dye product, such as Reversacol™ Rush Yellow of James Robinson Ltd., was used. Meanwhile, for the light absorption material 20 for absorbing light of the region A′ having the wavelength of 580±20 nm, a photochromic dye product, such as Reversacol™ Flame of James Robinson Ltd., was used.

In the exemplary embodiment as shown in FIG. 4, the diffusers 15 are included in the material of the main body 10 and the material of the main body 10 is extruded or injected to form a plate, and then the light absorption material 20 is coated on one surface, or both surfaces, of the plate.

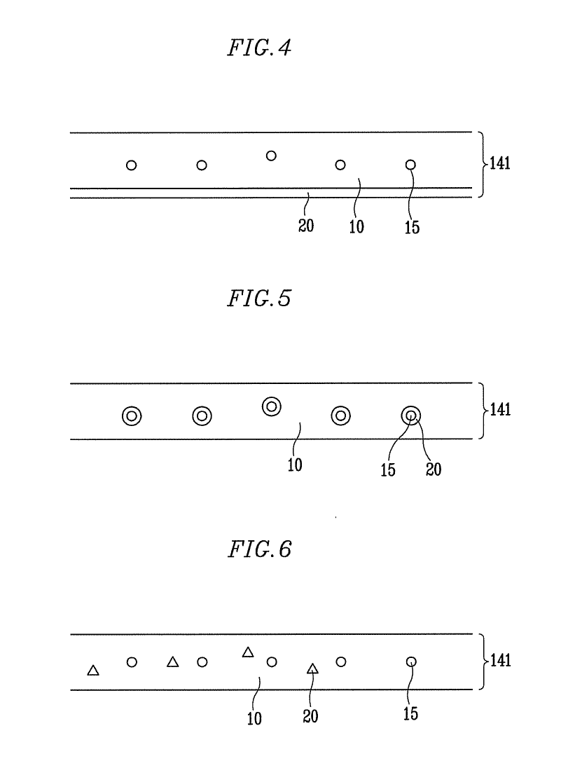

FIG. 5 shows an example in which the light absorption material 20 is coated on an outer surface of each diffuser 15, unlike the exemplary embodiment shown in FIG. 4.

The diffusion plate 141 according to the exemplary embodiment as shown in FIG. 5 has such a structure in which the plurality of diffusers 15 coated with the light absorption material 20 are diffused and distributed within the main body 10 of the diffusion plate 141. The plurality of diffusers 15 coated with the light absorption material 20 included in the diffusion plate 141 not only diffuse light but also remove light at the region A or A′ in FIG. 2.

The diffusion plate 141 according to the exemplary embodiment as shown in FIG. 5 is formed such that the light absorption material 20 is coated on the diffusers 15, which is then included in the material of the main body 10 and then extruded and injected to form the diffusion plate 141.

FIG. 6 shows an example of a diffusion plate 141 having a structure such that a plurality of light absorption materials 20 and a plurality of diffusers 15 are distributed together within the main body 10. Because light is transmitted via both the light absorption materials 20 and the diffusers 15 included in the main body 10 of the diffusion plate 141, light at the region A or A′ in FIG. 2 can be removed.

The diffusion plate 141 according to the exemplary embodiment as shown in FIG. 6 is formed such that the diffusers 15 and the light absorption materials 20 are included within the material of the main body 10, which is then extruded and injected to form the diffusion plate 141.

Optical characteristics of the exemplary embodiments of the diffusion plate 141 will now be described.

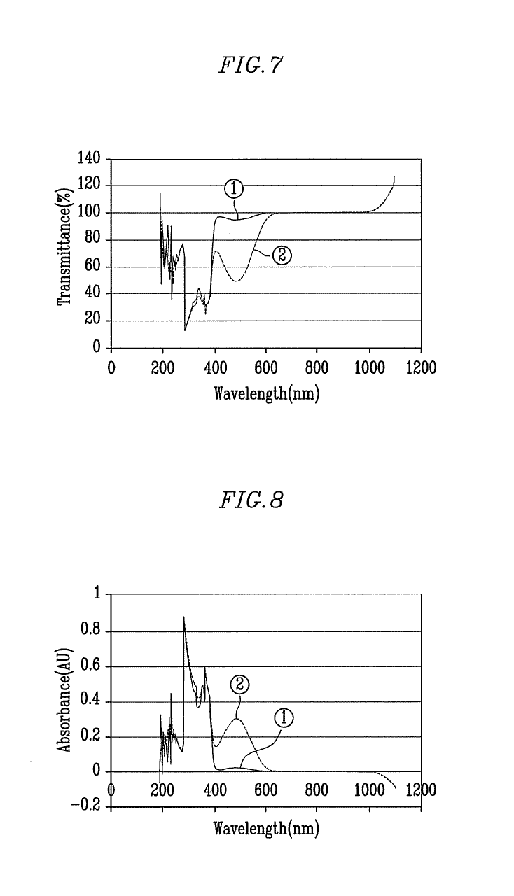

FIG. 7 is a graph showing transmission characteristics according to the exemplary embodiment of the present invention, and FIG. 8 is a graph showing transmission characteristics, related to absorbance, according to the exemplary embodiment of the present invention.

The diffusion plate according to the exemplary embodiment in FIGS. 7 and 8 includes only the light absorption material for absorbing light of the region A.

First, in FIGS. 7 and 8, curved line 1 indicates the related art case where the light absorption material is not included in the diffusion plate, and curved line 2 indicates a case where an exemplary light absorption material according to exemplary embodiments of the present invention is included in the diffusion plate.

With reference to FIG. 7, it is noted that, in the case of the related art (the curved line 1), light of the region A (having the wavelength of 480±20 nm) is transmitted as it is, and with reference to FIG. 8, light of the region A (having the wavelength 480±20 nm) is not almost absorbed.

Comparatively, it is noted that the exemplary diffusion plate according to exemplary embodiments of the present invention, as indicated by curved line 2, allows light of the region A (having the wavelength of 480±20 nm) to be only slightly transmitted therethrough as shown in FIG. 7, and absorbs much of the light of the region A (having the wavelength of 480±20 nm) as shown in FIG. 8.

While the graphs of FIGS. 7 and 8 are based on a diffusion plate including a light absorption material for absorbing light having the wavelength of 480±20 nm, it should be appreciated that results obtained for a diffusion plate including a light absorption material for absorbing light having the wavelength of 580±20 nm would demonstrate that light having the wavelength of 580±20 nm would only be slightly transmitted and mostly absorbed through the diffusion plate. Similarly, a diffusion plate having light absorption materials for absorbing light having the wavelength of 480±20 nm as well as for absorbing light having the wavelength of 580±20 nm would have the advantageous characteristics of only slightly transmitting and mostly absorbing light having the wavelengths of 480±20 nm and 580±20 nm.

The wavelengths of 480±20 nm and 580±20 nm respectively represent dummy wavelength ranges.

As ascertained from the content of FIGS. 7 and 8, in order to display different characteristics by absorbing light, it is preferred to generate a luminance difference of 20% or greater between light made incident on the diffusion plate and light transmitted through the diffusion plate at a particular region. Namely, it is preferable that the light absorption material reduces luminance of transmission light such that the luminance difference between light made incident on the diffusion plate and light transmitted through the diffusion plate is 20% or greater within the range of the region A or A′.

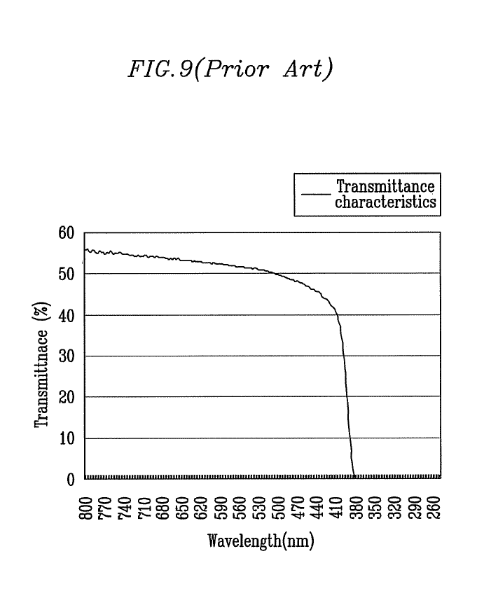

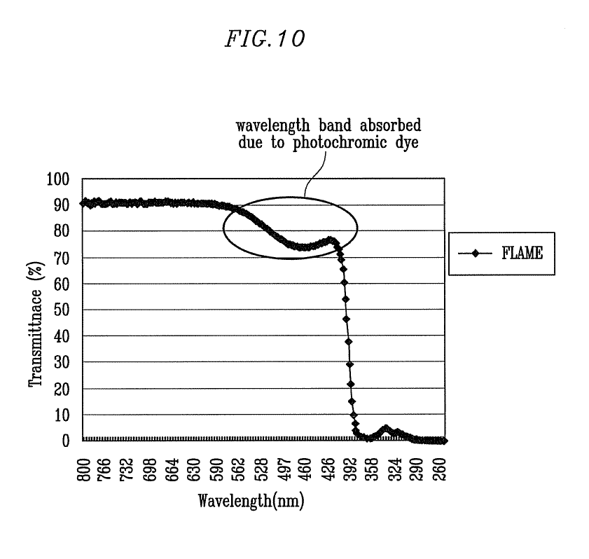

This can be confirmed through an experimentation result obtained as shown in FIGS. 9 and 10.

FIG. 9 is a graph showing characteristics of the related art diffusion plate through transmittance over wavelengths, and FIG. 10 is a graph showing characteristics of the diffusion plate according to an exemplary embodiment of the present invention through transmittance over wavelengths.

That is, as shown in FIG. 9, the related art diffusion plate allows light of the region A (having the wavelength of 480±20 nm) to be transmitted like the other wavelength bands, whereas the exemplary diffusion plate (as shown in FIG. 10) according to an exemplary embodiment of the present invention definitely reduces the amount of light within the wavelength range to be absorbed by the light absorption material, as compared with the other wavelength bands.

Accordingly, in spite of using the CCFL, the color reproducibility can be improved by adding the light absorption material for absorbing light of an unnecessary wavelength to the diffusion plate 141.

Color reproducibility in the case of using the light absorption material for absorbing light of the region A (having the wavelength of 480±20 nm) and that in case of using the light absorption material for absorbing light of the region A′ (having the wavelength of 580±20 nm) will now be described.

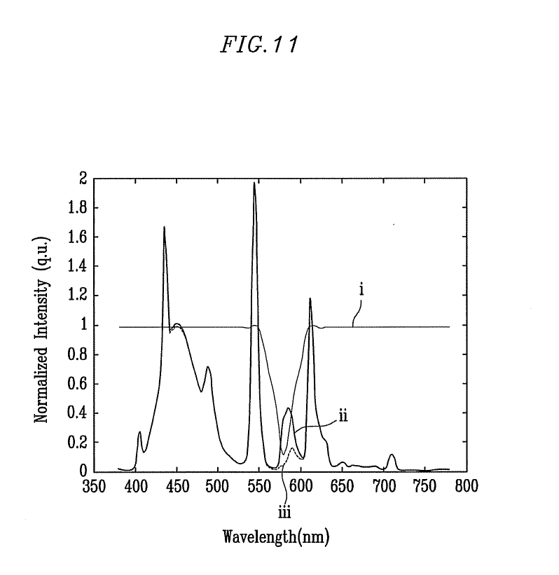

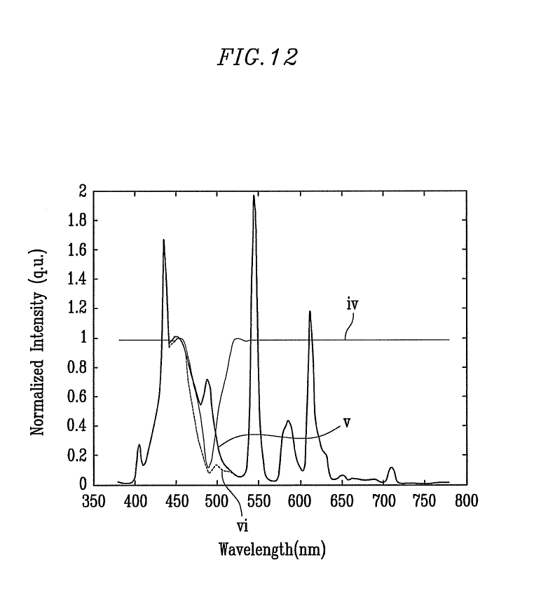

FIG. 11 is a graph showing characteristics according to wavelengths of light transmitting through an exemplary diffusion plate according to one exemplary embodiment of the present invention, and FIG. 12 is a graph showing characteristics according to wavelengths of light transmitting through an exemplary diffusion plate according to another exemplary embodiment of the present invention.

FIG. 11 shows a graph for an exemplary embodiment in which the light absorption material for absorbing light of the region A′ (having the wavelength of 580±20 nm) is used. The curved line i indicates transmission characteristics over wavelength bands of the light absorption material. Thus, the curved line i shows a significant loss of transmission within the range of wavelengths of 580±20 nm. The curved line ii indicates intensity of light over wavelengths after light emanated from the CCFL is transmitted through the LCD using the related art diffusion plate, and thus shows transmission of light within the region A′. The curved line iii indicate intensity of light over wavelengths after light emanated from the CCFL is transmitted through the exemplary LCD using the exemplary diffusion plate for absorbing light of the region A′.

In comparison of the curved lines ii and iii at the region A′ it is noted that intensity of the transmitted light is definitely reduced when the diffusion plate having the light absorption material is used. In particular, according to the present exemplary embodiment, at some portions, luminance of light was reduced by an amount of more than 50% when light was transmitted through the exemplary diffusion plate of the present invention. Consequently, although the CCFL is used, the color reproducibility can be enhanced by removing light of the unnecessary wavelength band.

In general, use of the CCFL in an LCD having a diffusion plate of the related art obtains color reproducibility remaining at some 72% compared with the NTSC method, whereas the color reproducibility can increase up to 80% in an LCD having an exemplary diffusion plate including the light absorption material according to the present invention.

FIG. 12 is a graph obtained when the light absorption material for absorbing light of the region A (having the wavelength of 480±20 nm) is used, in which the curved line iv indicates transmission characteristics over wavelength bands of the light absorption material. Thus, the curved line iv shows a significant loss of transmission within the range of wavelengths of 480±20 nm. The curved line v indicates intensity of light over wavelengths after light emanated from the CCFL is transmitted through the LCD using the related art diffusion plate, and thus shows transmission of light within the region A. In addition, the curved line vi indicates intensity of light over wavelengths after light emanated from the CCFL is transmitted through the exemplary LCD using the exemplary diffusion plate for absorbing light of the region A.

In comparison of the curved lines v and vi at the region A (having the wavelength of 480±20 nm), it is noted that intensity of the transmitted light is definitely reduced when the exemplary diffusion plate having the light absorbing material of the present invention is used. In particular, according to the present exemplary embodiment, at some portions, luminance of light was reduced by a maximum 70% when light was transmitted through the exemplary diffusion plate of the present invention. Consequently, although the CCFL is used, the color reproducibility in the LCD can be enhanced by removing light of the unnecessary wavelength band.

In general, use of the CCFL in an LCD having a diffusion plate of the related art obtains color reproducibility remaining at some 72% compared with the NTSC method, whereas the color reproducibility can increase up to 78% in an LCD having an exemplary diffusion plate including the light absorption material according to the present invention.

FIGS. 11 and 12 show the case where the wavelength band of either the region A or the region A′ is absorbed, so, notably, when the wavelength bands of the regions A and A′ are all absorbed, the color reproducibility can increase up to 90% compared with the NTSC method.

As described above, because the light absorption material for absorbing a light of a dummy wavelength range or noises is added to a diffusion plate to remove light of an unnecessary wavelength band or bands in using the CCFL, the color reproducibility can be enhanced. In addition, using a film or developing a light source itself to improve color reproducibility would increase costs, but in the present invention, because the light absorption material is simply included in the diffusion plate, a fabrication or development cost can be reduced, and because a production line is not necessary, costs can be saved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a backlight unit comprising a light source;
a liquid crystal panel displaying an image by using light provided from the light source; and
a light absorption element absorbing light of a dummy wavelength range.

2. The liquid crystal display of claim 1, wherein the light absorption element is formed in a diffusion plate.

3. The liquid crystal display of claim 2, the diffusion plate comprising:
a main body;
diffusers distributed in the main body; and
a light absorption element formed by a light absortion material,
wherein the light absorption material is included in the main body.

4. The liquid crystal display of claim 3, wherein the light absorption material is formed on one surface of the main body.

5. The liquid crystal display of claim 3, wherein the light absorption material is formed on a surface of the diffusers.

6. The liquid crystal display of claim 3, wherein the light absorption material is distributed in the main body.

7. The liquid crystal display of claim 3, wherein the light absorption material absorbs at least some light within a wavelength range of 480±20 nm.

8. The liquid crystal display of claim 7, wherein the light absorption material reduces luminance of light transmitting through the diffusion plate and a luminance difference between light made incident on the diffusion plate and light transmitting through the diffusion plate within the wavelength range is 20% or greater.

9. The liquid crystal display of claim 3, wherein the light absorption material absorbs at least some light within a wavelength range of 580±20 nm.

10. The liquid crystal display of claim 9, wherein the light absorption material reduces luminance of light transmitting through the diffusion plate and a luminance difference between light made incident on the diffusion plate and light transmitting through the diffusion plate within the wavelength range is 20% or greater.

11. The liquid crystal display of claim 3, wherein the light absorption material prevents at least some light having wavelengths between wavelengths of red and green light, and at least some light having wavelengths between wavelengths of green and blue light from transmitting through the diffusion plate.

12. The liquid crystal display of claim 3, wherein the light absorption material is a photochromic dye.

13. A method for manufacturing a diffusion plate, the method comprising:
manufacturing the diffusion plate having a light absorption material,
wherein the diffusion plate comprises a main body and diffusers distributed in the main body.

14. The method of claim 13, wherein the manufacturing of the diffusion plate further comprises
adding diffusers to be distributed in a main body to a material for forming the main body, and extruding or injecting the main body having the diffusers to form a plate; and
coating an absorption material on one surface of the plate.

15. The method of claim 13, wherein the manufacturing of the diffusion plate further comprises
coating a light absorption material on a surface of diffusers; and
adding the diffusers coated with the light absorption material to a material for forming a diffusion plate main body, and extruding or injecting the material forming a diffusion plate main body to form a diffusion plate.

16. The method of claim 13, wherein the manufacturing of the diffusion plate further comprises
adding diffusers, to be distributed in a main body of a diffusion plate, and a light absorption material to a material for forming the main body of the diffusion plate, and extruding or injecting the material for forming the main body to form the diffusion plate.

17. The method of claim 13, wherein the light absorption material absorbs at least some wavelengths of at least one of a first wavelength band of 480±20 nm and a second wavelength band of 580±20 nm.

18. A method for enhancing color reproducibility in a display device, the display device including a display panel and a backlight unit, the backlight unit including a light source and a diffusion plate, the diffusion plate having a main body material and diffusers, the method comprising:
adding a light absorption material to the diffusion plate, the light absorption material preventing transmission of at least some light within a wavelength band through the diffusion plate.

19. The method of claim 18, wherein the light absorption material prevents transmission of at least some light within at least one of two wavelength bands including a first wavelength band between 480±20 nm and a second wavelength band between 580±20 nm.

20. The method of claim 18, wherein adding a light absorption material to the diffusion plate includes adding a photochromic dye to the diffusion plate.
